(19) United States
(12) Patent Application Publication
(10) Pub. No.: US 2021/0240122 A1
(43) Pub. Date: Aug. 5, 2021

(54) SHEET CONVEYANCE DEVICE AND IMAGE FORMING DEVICE

(71) Applicant: CANON KABUSHIKI KAISHA, Tokyo (JP)

(72) Inventors: Takashi Fujita, Chiba (JP); So Matsumoto, Saitama (JP)

(21) Appl. No.: 17/165,780

(22) Filed: Feb. 2, 2021

(30) Foreign Application Priority Data
Feb. 5, 2020 (JP) 2020-018272

(51) Int. Cl. G03G 15/00; G06K 15/14; G06K 15/16

(52) U.S. Cl. CPC G03G 15/6567; G06K 15/14; G03G 2215/00527; G03G 15/6591; G06K 15/16

(57) ABSTRACT

A sheet conveyance device includes a conveyance unit, a skew conveyance unit, and an abutment unit. The conveyance unit conveys a sheet in a conveyance direction. The skew conveyance unit conveys the sheet in a first direction inclined to the conveyance direction. The skew conveyance unit is rotatable about an axial line orthogonal to the first direction. The abutment unit on which a side end portion of the sheet in a width direction of the sheet orthogonal to the conveyance direction of the sheet conveyed by the skew conveyance unit abuts. The abutment unit includes an abutment member extending in the conveyance direction and having a first surface, and a sheet member in a sheet form, wherein the sheet member is detachably attached to the first surface. The conveyed sheet is conveyed by the skew conveyance unit with the side end portion of the sheet abutting on the sheet member.

### BACKGROUND

### Field

The present disclosure relates to a sheet conveyance device that conveys a sheet and an image forming device that forms a toner image on the sheet.

### Description of the Related Art

In recent years, electrophotographic image forming devices have targeted at the light printing market (Print On Demand [POD] market), which provides a small number of copies, taking advantage of the fact that plates are not required, unlike in offset printing machines. However, in such a light printing market, the image forming device is required to achieve both the number of deliverables discharged per minute (hereinafter referred to as productivity of a device) and high printing accuracy of printed images.

Japanese Patent Application Laid-Open No. 2005-314045 discusses the device that a skew conveyance roller conveys the sheet diagonally relative to the conveyance direction of the sheet to an abutment portion provided along the conveyance direction of the sheet and having a reference surface, and corrects a skew of the conveyed sheet while the side end portion of the sheet is being abutted on the reference surface. This device enables correction of the skew of the sheet without stopping the sheet, thus achieving productivity of the device and high accuracy in printing images.

However, in recent years, it has been required to print a large amount of sheets, which leads to the occurrence of an abutment failure due to degradation of the reference surface caused by abutment of the side end portion of the sheet on the reference surface. For example, when the side end portion of label paper comes into contact with the reference surface of the abutment portion in conveying the label paper, an adhesive adheres to the reference surface, which degrades the reference surface. Maintainability of the degraded reference surface has not been taken into account.

### SUMMARY

The present disclosure is directed to providing a sheet conveyance device having improved maintainability of a reference surface in a configuration in which a sheet is abutted on the reference surface to correct skew.

According to an aspect of the present disclosure, sheet conveyance device includes a conveyance unit configured to convey a sheet in a conveyance direction, a skew conveyance unit configured to convey the sheet in a first direction inclined to the conveyance direction, wherein the skew conveyance unit is rotatable about an axial line orthogonal to the first direction, and an abutment unit on which a side end portion of the sheet in a width direction of the sheet orthogonal to the conveyance direction of the sheet conveyed by the skew conveyance unit abuts, wherein the abutment unit includes: an abutment member extending in the conveyance direction and having a first surface, and a sheet member in a sheet form, wherein the sheet member is detachably attached to the first surface, and wherein the conveyed sheet is conveyed by the skew conveyance unit with the side end portion of the sheet abutting on the sheet member.

Further features of the present disclosure will become apparent from the following description of exemplary embodiments with reference to the attached drawings.

### BRIEF DESCRIPTION OF THE DRAWINGS

FIG. 1 is a sectional view of an image forming device according to an exemplary embodiment of the present disclosure.

FIGS. 2A, 2B, 2C, and 2D are each a top view illustrating skew correction of a sheet in a resist portion according to the exemplary embodiment of the present disclosure.

FIG. 3 is a sectional view of an abutment reference section according to a first exemplary embodiment of the present disclosure.

FIG. 4 is a side view of the abutment reference section according to the first exemplary embodiment of the present disclosure.

FIG. 5 is an enlarged sectional view of the abutment reference section according to the first exemplary embodiment of the present disclosure.

FIG. 6 is a sectional view of an abutment reference section according to a second exemplary embodiment of the present disclosure.

FIGS. 7A and 7B are each a sectional view of an abutment reference section according to a third exemplary embodiment of the present disclosure.

FIGS. 8A and 8B are each a side view of the abutment reference section according to the third exemplary embodiment of the present disclosure.

FIG. 9 is a sectional view of an abutment reference section according to a fourth exemplary embodiment of the present disclosure.

FIGS. 10A and 10B are each a sectional view of the abutment reference section according to the fourth exemplary embodiment of the present disclosure.

### DESCRIPTION OF THE EMBODIMENTS

### (Image Forming Device)

Exemplary embodiments of the present disclosure will be described below with reference to the accompanying drawings.

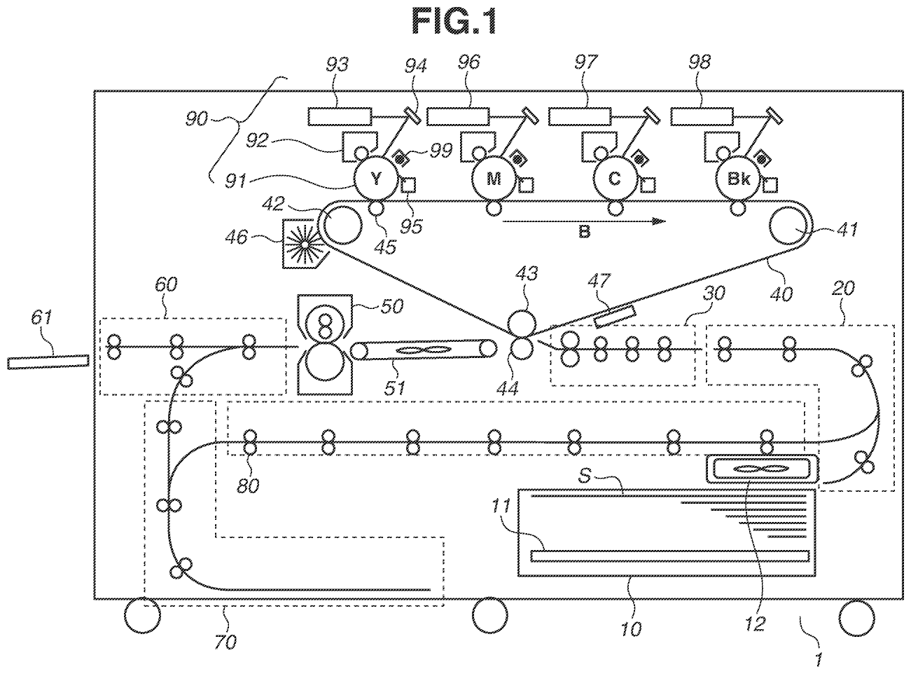

A first exemplary embodiment of the present disclosure will be described below. An image forming device 1 to which the present disclosure is applied will be initially described with reference to FIG. 1. FIG. 1 is a sectional view of the image forming device 1 according to the first exemplary embodiment.

A sheet S, which is a transfer material, is loaded and stored on a lift-up device 11 which is a part of a sheet conveyance device 10. The start of conveying the loaded sheet S performed by a sheet conveyance unit 12 is timed to the image forming timing of an image forming mechanism 90. Here, regarding the sheet separation of the sheet conveyance unit 12, there are a method in which friction separation by using a roller or the like is used, a method in which separation and suction by air is used, and other methods. In this exemplary embodiment, a sheet conveyance method using separation and suction by air is adopted. The sheet S, which is a transfer material, has been required to convey not only plain paper and glossy paper, but also special paper, such as film sheet, synthetic sheet, magnet sheet, and label paper in recent years.

In a method using friction separation of a roller or the like in conveying, for example, label paper, a plurality of overlapping sheets of label paper is separated one by one. At this time, since the force to peel off the label is applied especially to the edge portion of the tip of the label paper, if the label paper is rolled up minutely, the label may be rolled up in the conveyance path from that point and a paper jam may occur. Meanwhile, in the sheet conveyance device 10 that utilizes the separation and suction by air according to the present exemplary embodiment, the sheet is suctioned one by one to the belt by the suction force of the air and then the sheet is conveyed. Thus, such a large force that peels off the label does not act on the edge portion of the tip of the label paper.

The sheet S sent out by the sheet conveyance unit 12 passes through a conveyance path of a conveyance unit 20 and is conveyed to a registration unit 30. The conveyed sheet S is subjected to a skew correction by a skew correction section 55 provided at the registration unit 30. Then, the sheet S is subjected to correction of the timing for alignment with an image at a secondary transfer section. The sheet S is then conveyed to the secondary transfer section. The secondary transfer section is a transfer nip section formed by a secondary transfer inner roller 43 and a secondary transfer outer roller 44 facing each other, and transfers, to the sheet S, a toner image (unfixed image) on an intermediate transfer belt 40 by applying a predetermined pressing force and a predetermined electrostatic load bias.

Next, a description will be provided of an image forming process through which the toner image transferred to the sheet S is formed and sent to the secondary transfer section.

In FIG. 1, an image forming mechanism 90 mainly includes a photosensitive drum 91, an exposure device 93, a developing device 92, a primary conveyance device 45, and a photosensitive cleaner 95. The exposure device 93 emits light based on the sent signal of image information to the photosensitive drum 91 which has a surface uniformly charged by a charging unit (not illustrated) and is rotatable counterclockwise in FIG. 1, and a latent image is formed via a reflecting unit 94. The electrostatic latent image formed on the photosensitive drum 91 in such a way is subjected to toner development by the developing device 92, and a toner image is formed on a photosensitive body. After that, a predetermined pressing force and a predetermined electrostatic load bias are applied by the primary conveyance device 45, and the toner image is transferred onto the intermediate transfer belt 40. After the primary transfer to the intermediate transfer belt 40, the photosensitive cleaner 95 collects transfer residual toner remaining on the photosensitive drum 91.

In the case of the image forming mechanism 90 described above, four image forming units of yellow (Y), magenta (M), cyan (C), and black (Bk) are provided. The colors are not limited to four, and the order of colors is not limited to this.

Next, a description will be provided of the intermediate transfer belt 40. The intermediate transfer belt 40 is tightly stretched by a plurality of rollers such as a drive roller 42, a tension roller 41, and the secondary transfer inner roller 43, and is rotationally driven in the direction of an arrow B in FIG. 1. Images of each color processed in parallel by the corresponding one of the Y, M, C, and Bk image forming units described above are sequentially superimposed on an upstream toner image primary-transferred on the intermediate transfer belt 40. As a result, a full color toner image is finally formed on the intermediate transfer belt 40 and conveyed to the secondary transfer section.

The full color toner image is secondarily transferred onto the first surface of the sheet S in the secondary transfer section through the sheet conveyance process and the image formation process described above. After the toner image is secondarily transferred to the sheet S, transfer residual toner remaining on the surface of the intermediate transfer belt 40 is collected by the belt cleaner 46.

The sheet S to which the toner image is transferred is conveyed to the fixing device 50 by a pre-fixing conveyance section 51. In the fixing device 50, the toner is fused and fixed on the sheet S by a predetermined pressing force by an opposing roller, belt or the like, and generally by being heated with a heat source such as halogen heater. The sheet S having the fixed image thus obtained is discharged without change onto the paper ejection tray 61 by a branch conveyance device 60, or is conveyed to a reverse conveyance device 70 in a case where a double-sided image formation is performed.

The sheet S conveyed to the reverse conveyance device 70 is conveyed to a double-sided conveyance device 80 by exchanging the front and rear ends of the sheet S by performing a switchback operation. After that, the sheet S conveyed to the double-sided conveyance device 80 is merged with the conveyance unit 20 according to the timing with the sheet S to be conveyed from the sheet conveyance device 10, and is conveyed to the secondary transfer section. An image is formed on the second surface of the sheet S, which is the opposite side of the first surface of the sheet S described above. The image formation process for the second side of the sheet S is similar to the one for the first side, and thus, a description thereof is omitted.

In the present exemplary embodiment, the image forming section that forms an image on the sheet S includes the secondary transfer section including the image forming mechanism 90, the intermediate transfer belt 40, the secondary transfer inner roller 43, and the secondary transfer outer roller 44, and the fixing device 50, etc.

### <Registration Unit>

Next, the registration unit 30 of the present exemplary embodiment will be described in detail.

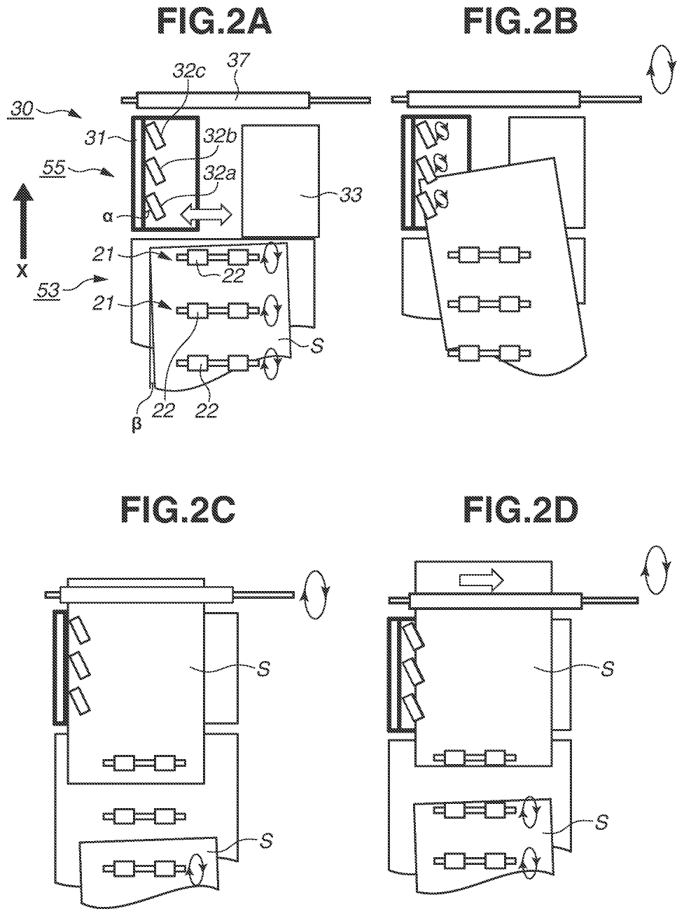

FIGS. 2A, 2B, 2C, and 2D are each a top view illustrating a general view of the registration unit 30 of FIG. 1. The registration unit 30 includes a conveyance roller section 53 having conveyance rollers 21 which are each a conveyance unit for conveying the sheet S, the skew correction section 55 for correcting the skew of the sheet S, and a resist roller 37 that corrects the position of a side end portion of the sheet S and conveys the sheet S to the secondary transfer section.

FIG. 2A illustrates the registration unit 30 while the sheet S skewed at a skew angle β with respect to the sheet conveyance direction is being conveyed by the conveyance rollers 21 FIG. 2B illustrates the registration unit 30 while the sheet S is being conveyed by skew conveyance rollers 32a, 32b, and 32c (hereinafter, also collectively referred to as “skew conveyance roller 32”) provided at the skew correction section 55. FIG. 2C illustrates the registration unit 30 while the sheet S having been subjected to a skew correction by the skew correction section 55 is being conveyed by the resist roller 37. FIG. 2D illustrates the registration unit 30 while the sheet S being conveyed by the resist roller 37 is being moved in the direction of an axis.

The skew correction section 55 mainly includes a movable guide and a fixed guide 33. The movable guide is moveable, according to the size of the sheet S, in the width direction orthogonal to an arrow X which is the sheet conveyance direction, and includes an abutment reference section 31 serving as an abutment unit and a plurality of skew conveyance rollers 32a, 32b, and 32c each serving as a skew conveyance unit. The abutment reference section 31 serves as a reference plate for correcting the skew of the sheet S by abutting the side end portion of the sheet S passing through the sheet conveyance path. The skew conveyance rollers 32 are each located on the downstream side of the conveyance rollers 21 in the sheet conveyance direction, and is tilted at an angle α with respect to the sheet conveyance direction (a first direction). The skew conveyance rollers 32 is rotatable about an axial line about which the skew conveyance roller 32 rotates. The sheet S to be conveyed is arranged so as to approach the abutment reference section 31 as the sheet S is conveyed further downstream in the sheet conveyance direction. That is, the skew conveyance rollers 32a, 32b, and 32c convey the sheet S by applying, to the sandwiched sheet S, a force in the direction inclined to the sheet conveyance direction. The fixed guide 33 is immovable regardless of the size of the sheet S, and functions as a conveyance guide for the sheet S to be conveyed.

Next, the conveyance operation of the sheet S in the registration unit 30 will be described. Assume that the sheet S skewed at the skew angle β as illustrated in FIG. 2A is conveyed to the skew correction section 55 by the conveyance rollers 21. The sheet S sent to the skew conveyance rollers 32 of the skew correction section 55 is obliquely conveyed toward the abutment reference section 31 as illustrated in FIG. 2B. At the point when the respective skew conveyance rollers 32 start conveying the sheet S, a nip of respective pairs of driven rollers 22 of the corresponding conveyance roller 21 is separated by an actuator (not illustrated).

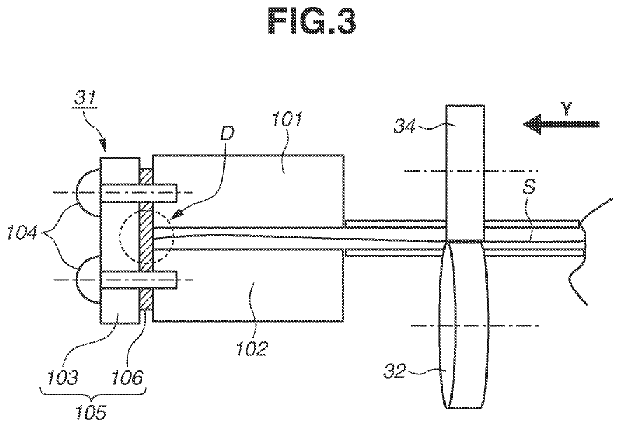

As illustrated in FIGS. 2B and 2C, the sheet S is conveyed with the side end portion of the sheet S following the abutment reference section 31, which corrects the skew of the sheet S. In this state, the sheet S with the skew thereof corrected is sandwiched by the resist roller 37. When the sheet S is sandwiched by the resist roller 37, a pressurizing roller 34 (illustrated in FIG. 3) arranged opposite to the respective skew conveyance rollers 32 is released by an actuator (not illustrated). After that, as illustrated in FIG. 2D, the resist roller 37 is slid by a certain amount in the width direction orthogonal to the sheet conveyance direction, so that an alignment with the position of the image formed on the intermediate transfer belt 40 is performed (horizontal registration). The above control regarding the rotation and stop of each roller and the operation of abutting or separating each roller pair are performed by a controller (not illustrated) in the main body. As described above, a series of operations illustrated in FIGS. 2A, 2B, 2C, and 2D realizes a highly productive device while correcting the skew of the sheet S, without stopping the sheet S.

### <Structure of Abutment Reference Section>

FIG. 3 is a sectional view of the abutment reference section 31 in FIGS. 2A, 2B, 2C, and 2D as viewed from the upstream side (arrow X) in the conveyance direction of the sheet S. The abutment reference section 31 includes an upper guide 101 serving as a first guide member, a lower guide 102 serving as a second guide member, a reference guide 103 serving as a reference guide member, and a sheet member 106 (also referred to as slidable sheet 106).

The upper guide 101, the lower guide 102, and the reference guide 103 of the abutment reference section 31 are made of metal, and these serve as abutment members. As illustrated in FIG. 3, the abutment reference section 31 is formed in a substantially squared C-shape in the cross section, the upper guide 101 and the lower guide 102 are arranged to face each other, and the reference guide 103 is located substantially perpendicular to the upper guide 101 and the lower guide 102. The abutment member has an abutment surface which is a first surface on which the side end portion of the sheet S conveyed by the skew conveyance rollers 32 abuts. The upper guide 101 and the lower guide 102 are each fastened to the reference guide 103 by the corresponding one of screws 104 serving as a fixing unit. Further, a slidable sheet 106 serving as a sheet member in sheet form having high releasability is attached to the abutment surface. That is, the slidable sheet 106 is provided to be sandwiched between both the bracket 103 serving as the reference guide 103 and the upper guide 101, and the bracket 103 and the lower guide 102, and the abutment of the side end portion of the sheet S conveyed on the slidable sheet 106 corrects the skew of the sheet S. The slidable sheet 106 is removable from the bracket 103 and is configured to be easily replaced.

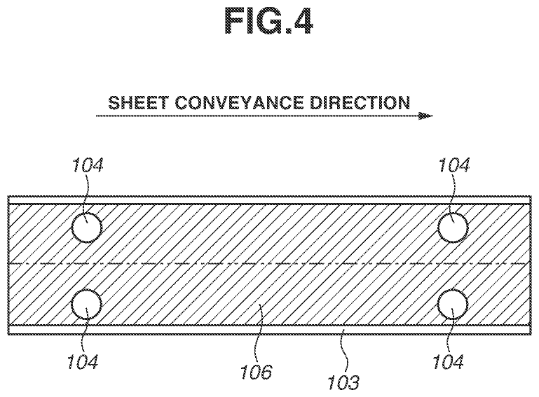

FIG. 4 is a view illustrating the reference guide 103 in FIG. 3 viewed from the direction Y. The slidable sheet 106 is attached to the bracket 103. As illustrated in FIG. 4, the position of the end portion of the slidable sheet 106 in the sheet conveyance direction is the same as the position of the end portion of the bracket 103. A two-dot chain line illustrated in FIG. 4 indicates the position at which the side end portion of the sheet S comes into contact.

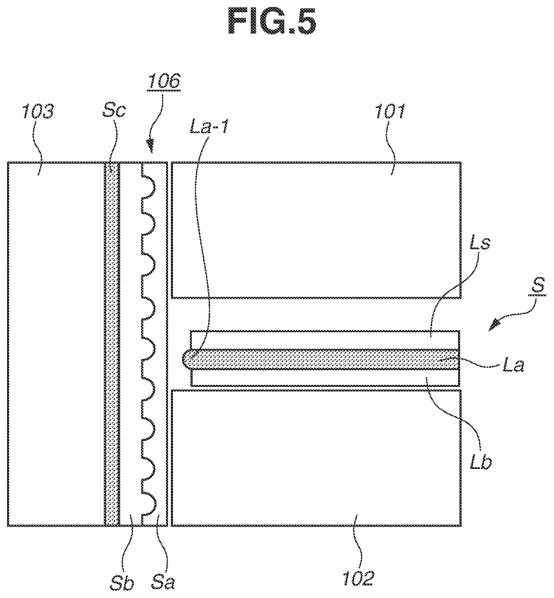

FIG. 5 illustrates an enlarged view of a circle D in FIG. 3, which is a view when the side end portion of label paper S comes into contact with the reference guide 103. FIG. 5 further illustrates a lamination of the formed materials of each of the label paper S and the slidable sheet 106. Generally, the label paper S includes three elements, specifically, a label surface Ls which is a surface base material, an adhesive La, and releasable paper Lb. The adhesive La is applied to the back surface of the label surface Ls, and releasable paper Lb with good releasability is provided via the adhesive La. An image is to be formed on the surface of the label surface Ls, and the resultant label paper S, which is a deliverable, is attached to other objects after a user peels off the releasable paper Lb. Normally, the label paper S to be conveyed is cut from a long sheet roll with a cutter, and each is a cut piece. In the cut label paper S, due to the pressure at the time of cutting and/or due to the adhesive adhering to the knife at the time of cutting being pulled, the adhesive La may slightly protrude from the side end face of the label paper S, as with La-1. In such a case, when the side end portion of the sheet S is conveyed while being abutted on the metal bracket 103, the adhesive may adhere to the bracket 103 side. As a result, the conveyance resistance acting on the sheet S in contact with the bracket 103 sharply rises, conveyance defects may occur relatively early, and paper jam, etc. may occur.

Accordingly, in the present exemplary embodiment, the slidable sheet 106 in sheet form is attached to the surface of the bracket 103. The slidable sheet 106 is obtained by impregnating, with a fluorine-based resin (PTFE) Sa, the first surface of a glass cloth Sb woven from a glass fiber serving as a base material, and further by applying a silicone-based adhesive (L) to the second surface on the opposite side of the first surface of the glass cloth Sb. As a result, even in conveying the label paper S having the adhesive La-1 protruding from the side end portion of the sheet S, the adhesive La-1 is difficult to adhere due to an effect of the fluorine-based resin having high releasability. Since the base material is the glass cloth Sb and minor irregularities are formed on its surface, the contact with the side end portion of the sheet S becomes point contact instead of line contact, so that the contact area becomes smaller. In this respect, it is advantageous for the adhesion of an adhesive.

In an experiment conducted by the inventor, in a case where the slidable sheet 106 was not attached to the bracket 103, a paper jam occurred with about 500 sheets of paper passed through. However, in a case where the slidable sheet 106 is attached to the bracket 103, it was confirmed that no paper jam occurs even with 10,000 or more sheets of paper passed through. Thus, it was confirmed that the effect brought about is at least 20 times or more.

Meanwhile, although the glass cloth Sb is adopted as the base material, the wear resistance of the surface of the slidable sheet 106 is inferior to that of metal, so that it is necessary to consider exchangeability for maintenance. In devices for commercial printing, a period of time in which the device is stopped (downtime) is one of major matters.

In the present exemplary embodiment, since the bracket 103 and the slidable sheet 106 are integrated, the bracket 103 and the slidable sheet 106 can be integrally replaced by removing the screws 104 in four places. The cost of parts to be replaced may be decreased by replacing only the slidable sheet 106 from the bracket 103 after removal of the bracket 103 and the slidable sheet 106 as a unit.

As described above, in the first exemplary embodiment, the slidable sheet 106 having higher releasability than that of the surface of the metal bracket 103 is provided on the bracket 103, and the side end portion of the label paper S conveyed is brought into contact with the surface portion of the slidable sheet 106. As a result, it is possible to reduce or prevent adhesion of the adhesive of the label paper S to the bracket 103. Since the bracket 103 and the slidable sheet 106 can be easily replaced by removing the screws 104 from the upper guide 101 and the lower guide 102, it is possible to improve the maintenance. In the first exemplary embodiment, the sheet S to be conveyed is the label paper, and the adhesive is illustrated as an example of a material which degrades the reference surface, but this is not restrictive. The first exemplary embodiment is applicable also to any substance that degrades the state of the reference surface, for example, paper powder, dust or the like which may adhere to the sheet S.

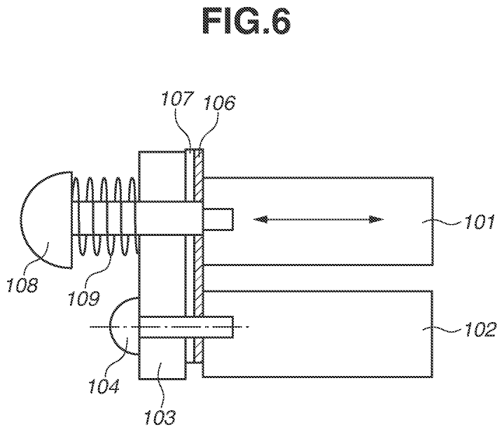

A second exemplary embodiment of the present disclosure will be described below. FIG. 6 is a diagram illustrating the second exemplary embodiment of the present disclosure. In the second exemplary embodiment, the method of fastening the upper guide 101 and the bracket 103 in the abutment reference section 31 of the skew correction section 55 is different from that of the first exemplary embodiment. In FIG. 6, the same numbers refer to the same functions as those described above, and thus, descriptions thereof are omitted.

In the second exemplary embodiment, the upper guide 101 biases the bracket 103 toward the upper guide 101 side by a compression spring 109 serving as a biasing member provided at the waist portion of a step screw 108. Since the screw-based fastening force of the step screw 108 with the upper guide 101 is stronger than the spring-based biasing force of the step screw 108 with the bracket 103, the upper guide 101 is movable in the arrow direction in FIG. 6 with respect to the bracket 103. Thus, in the second exemplary embodiment, the slidable sheet 106 can be removed from the bracket 103 by removing only the screw 104 from the lower guide 102 without removing the step screw 108 from the upper guide 101.

Further, the thickness of the slidable sheet 106 is about 0.3 mm, and the slidable sheet 106 does not have resilience. Thus, the slidable sheet 106 may be wrinkled when replaced. Thus, in the second exemplary embodiment, the slidable sheet 106 is bonded with an adhesive to a flexible sheet member 107 having high hardness, such as a polyethylene terephthalate ([PET], made from resin) sheet, and is integrated therewith.

As described above, in the second exemplary embodiment, the fixing unit for biasing the upper guide 101 and the bracket 103 with the step screw 108 and the compression spring 109 is adopted. As a result, the slidable sheet 106 can be replaced without removal of the upper guide 101 from the bracket 103, thus facilitating the maintenance.

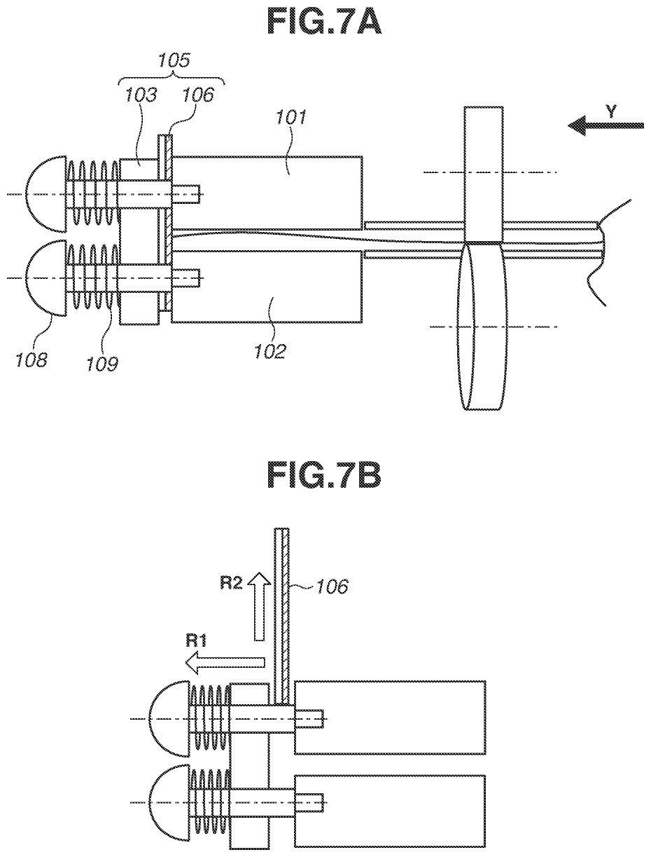

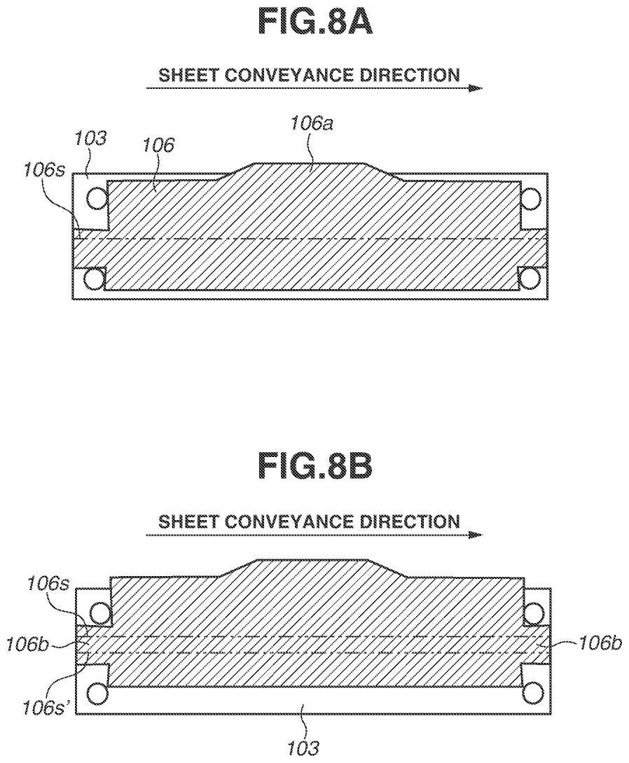

A third exemplary embodiment of the present disclosure will be described below. FIGS. 7A and 7B and FIGS. 8A and 8B are diagrams illustrating the third exemplary embodiment of the present disclosure. The third exemplary embodiment is a mode in which the method of fastening the lower guide 102 and the bracket 103 is changed, in addition to the abutment reference section 31 of the skew correction section 55 of the second exemplary embodiment. In FIGS. 7 and 8, the same numbers refer to the same functions as those described above, and thus, descriptions thereof are omitted.

In the third exemplary embodiment, as illustrated in FIG. 7A, both the upper guide 101 and the lower guide 102 are fixed to the bracket 103 by the step screws 108 and the spring 109. As illustrated in FIG. 7B, the slidable sheet 106 can be removed in the direction of an arrow R2 by moving the bracket 103 in the direction of an arrow R1. FIG. 8A is a view of the reference guide 103 in FIG. 7A viewed from the direction Y. In FIG. 8A, the slidable sheet 106 is provided with a grip portion 106a protruding from the upper end portion of the bracket 103 in the sectional direction parallel to and orthogonal to the sheet conveyance direction. This configuration improves the maintenance in removing and attaching the slidable sheet 106 from/to the bracket 103.

In FIG. 8A, a two-dot chain line portion 106s depicted on the slidable sheet 106 is a position at which the side end portion of the conveyed sheet S comes into contact in an abutting manner, and wear of the slidable sheet 106 occurs along the two-dot chain line portion 106s. FIG. 8B is a diagram in which the slidable sheet 106 of FIG. 8A is moved upward with respect to the bracket 103. If the contact position at which the conveyed sheet S abuts has become worn, changing of the contact position from the position 106s to the position 106s′ excludes the need of replacing the slidable sheet 106 and enables the slidable sheet 106 to be continuously used. In the present exemplary embodiment, the slidable sheet 106 is provided with two convex portions 106b extending in the sheet conveyance direction. Fixing the convex portions 106b to a position where the convex portions 106b abuts on the step screws 108 provided on the upper side causes the side end portion of the sheet S to be contact with the slidable sheet 106 at the position 106s′.

As described above, in the third exemplary embodiment, the fixing unit in which the upper guide 101 and the bracket 103 are biased by the step screw 108 and the compression spring 109, and further the lower guide 102 and the bracket 103 are biased by the step screw 108 and the compression spring 109. As a result, the slidable sheet 106 can be replaced by moving the bracket 103 in the direction of the arrow R1 with respect to the upper guide 101 and the lower guide 102, without removal of the bracket 103 from the upper guide 101 and the lower guide 102. That is, the third exemplary embodiment is an embodiment in which the maintenance is further improved as compared with the second exemplary embodiment. Configuring the slidable sheet 106 so that the position of the slidable sheet 106 can be changed with respect to the bracket 103 also leads to a reduction in the cost of the slidable sheet 106.

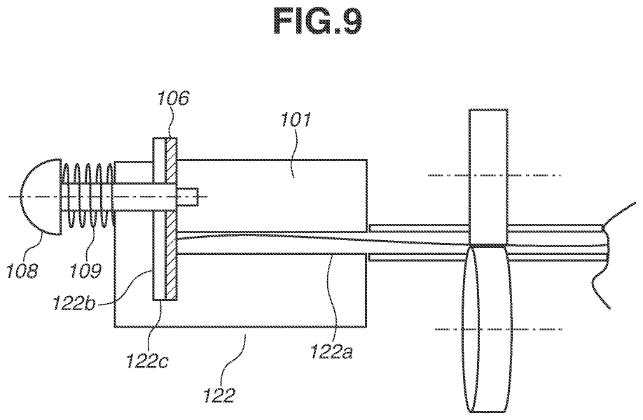

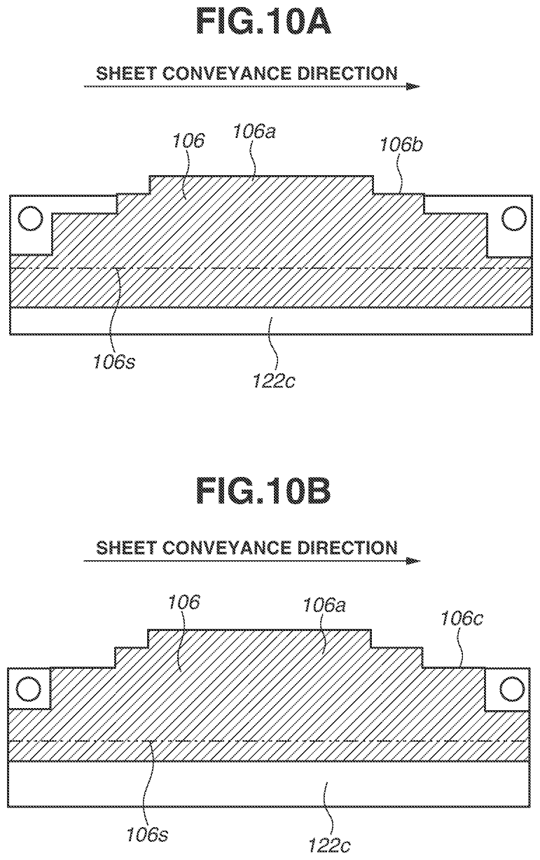

A fourth exemplary embodiment of the present disclosure will be described below. FIGS. 9 and FIGS. 10A and 10B are diagrams illustrating the fourth exemplary embodiment of the present disclosure. The fourth exemplary embodiment is an embodiment in which the bracket 103 and the lower guide 102 are integrated in the abutment reference section 31 of the second exemplary embodiment. In FIGS. 9 and 10, the same numbers refer to the same functions as those described above, and thus, descriptions thereof are omitted.

In the present exemplary embodiment, the upper guide 101 is biased to a substantially L-shaped lower guide 122 via the step screw 108 and the compression spring 109. Specifically, as illustrated in FIG. 9, a slit portion 122c is provided on the lower guide 122 side in a section where a lower guide surface 122a of the substantially L-shaped lower guide 122 intersects with a reference surface 122b on which the side end portion of the sheet S abuts. The slidable sheet 106 is arranged to be bonded to the reference surface 122b by the lower portion of the slidable sheet 106 being inserted into the slit portion 122c. The upper portion of the slidable sheet 106 is sandwiched between the reference surface 122b and the upper guide 101 and fixed.

As illustrated in the third exemplary embodiment, the slidable sheet 106 is sandwiched with the position of the two-dot chain line portion 106s at which the side end portion of the sheet S abuts being shifted, so that it is possible to set a new sliding surface as an abutment reference surface without replacement of the slidable sheet 106. More specifically, a first position is a position at which a lower portion of the slidable sheet 106 abuts on a lower end portion of the slit portion 122c, and as a second position, the upper surface of the upper guide 101 is aligned with an edge portion 106b of the slidable sheet 106. Similarly, as a third position, aligning an edge portion 106c of the slidable sheet 106 enables the slidable sheet 106 to be continuously used. As in the third exemplary embodiment, the grip portion 106a can be held when aligning the position of the slidable sheet 106, so that the alignment can be easily performed. In the present exemplary embodiment, the edge shape is used as an index of the vertical position of the slidable sheet 106, however, a scale may be provided on the slidable sheet 106 by marking or printing.

As described above, in the fourth exemplary embodiment, the fixing unit for biasing the upper guide 101 to the substantially L-shaped lower guide 122 by the step screw 108 and the compression spring 109 is adopted. As a result, the slidable sheet 106 can be replaced without removal of the upper guide 101 from the substantially L-shaped lower guide 122, thus further improving the maintenance. Allowing the slidable sheet 106 to be repositioned with respect to the bracket 103 also leads to a reduction in the cost of the slidable sheet 106.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-018272, filed Feb. 5, 2020, which is hereby incorporated by reference herein in its entirety.

What is claimed is:

1. A sheet conveyance device comprising:
a conveyance unit configured to convey a sheet in a conveyance direction;
a skew conveyance unit configured to convey the sheet in a first direction inclined to the conveyance direction, wherein the skew conveyance unit is rotatable about an axial line orthogonal to the first direction; and
an abutment unit on which a side end portion of the sheet in a width direction of the sheet orthogonal to the conveyance direction of the sheet conveyed by the skew conveyance unit abuts,
wherein the abutment unit includes:
an abutment member extending in the conveyance direction and having a first surface, and
a sheet member in a sheet form, wherein the sheet member is detachably attached to the first surface, and
wherein the conveyed sheet is conveyed by the skew conveyance unit with the side end portion of the sheet abutting on the sheet member.

2. The sheet conveyance device according to claim 1, wherein the abutment member is made of metal, and a surface of the sheet member is higher in slidability than the first surface of the abutment member.

3. The sheet conveyance device according to claim 1,
wherein the abutment member includes:
a first guide member configured to guide a first surface of the sheet conveyed by the skew conveyance unit,
a reference guide member to which the sheet member is attached, and
a second guide member provided at a position facing the first guide member and configured to guide a second surface opposite to the first surface of the sheet, and
wherein the abutment member is formed in a substantially squared C shape in a section in the width direction of the sheet orthogonal to the conveyance direction.

4. The sheet conveyance device according to claim 3,
wherein the abutment member further includes a fixing unit configured to fasten the first guide member and the reference guide member and to fasten the second guide member and the reference guide member, and
wherein the sheet member is arranged so as to be sandwiched between the reference guide member and the first guide member and between the reference guide member and the second guide member.

5. The sheet conveyance device according to claim 4,
wherein the abutment member further includes a biasing member provided between the fixing unit and the reference guide member, and
wherein the sheet member is attachable to and detachable from the reference guide member with the fixing unit not being removed from the first guide member and the second guide member.

6. The sheet conveyance device according to claim 4, wherein the fixing unit fixes the reference guide member to the first guide member and the second guide member at a plurality of positions parallel to the conveyance direction of the sheet.

7. The sheet conveyance device according to claim 4, wherein the sheet member has a grip portion that protrudes from an upper end portion of the reference guide member in a sectional direction parallel to and intersecting the conveyance direction of the sheet.

8. The sheet conveyance device according to claim 1, wherein a base material of the sheet member is made of a glass cloth, and a surface of the base material is impregnated with a fluorine-based resin.

9. The sheet conveyance device according to claim 8,
wherein the sheet member further includes a flexible sheet member made of a resin having high hardness, and
wherein the flexible sheet member is bonded to the reference guide member.

10. The sheet conveyance device according to claim 1, wherein the abutment member includes:
a first guide member configured to guide a first surface of the sheet conveyed by the skew conveyance unit, and
a second guide member provided at a position facing the first guide member and configured to guide a second surface opposite to the first surface of the sheet and to guide the side end portion of the sheet.

11. The sheet conveyance device according to claim 10,
wherein the second guide member has a slit portion into which the sheet member is inserted, and
wherein a lower portion of the sheet member is inserted into the slit portion so that the sheet member is fixed by the lower portion of the sheet member being bonded to the second guide member.

12. An image forming device comprising:
the sheet conveyance device according to claim 1; and
an image forming unit configured to form an image on a sheet conveyed by the sheet conveyance device.
